(19) United States
(12) Patent Application Publication
(10) Pub. No.: US 2014/0084496 A1
(43) Pub. Date: Mar. 27, 2014

(54) PACKING ELEMENT

(71) Applicant: ROBERT LAWRENCE MILLER, Venice, FL (US)

(72) Inventor: ROBERT LAWRENCE MILLER, Venice, FL (US)

(21) Appl. No.: 13/626,529

(22) Filed: Sep. 25, 2012

(51) Int. Cl. B01J 19/30; B65B 5/00; B23P 17/00

(52) U.S. Cl. 261/94; 29/592; 53/473

(57) ABSTRACT

An improved packing element configured to reduce or eliminate nesting between packing elements in a column.

### FIELD

A packing element for use to create a bed in a process vessel such as a column, chamber, or tower for mass transfer or heat transfer applications, and a process of treating fluid.

### BACKGROUND OF THE INVENTION

In mass transfer or heat transfer applications, the sum of the geometric surface area of a packed bed of packing elements as well as the void spaces between the packing elements, play a significant role in the performance of the packing elements in the packed bed. In general, the greater the surface area of the packing elements in a packed bed, the greater the mass/heat transfer rate in the packed bed.

Further, in general the greater the total void space in a packed bed, the lesser the energy usage by the mass/heat transfer application. It is noted that the total void space itself is not the lone factor in determining the energy usage. There are several factors involved, including the overall size of the packing element as a key factor. This is more easily understood when looking at fluid flow through a packed bed of spheres. The total void space in a bed of spheres is the same (approx. 40%) regardless of sphere diameter, yet is will take more energy to push a process gas through a bed of ⅛″ sphere elements than a bed of 3″ spheres. The primary reason is that there are larger but fewer individual voids that make up the total void space when using the 3″ spheres.

A tower packing element for gas-contact and liquid-contact (i.e. “Original” Saddle) is disclosed in U.S. Pat. No. 2,639,909 to Leva, which U.S. patent is fully incorporated by reference herein. The packing element shown is generated by rotation of half-circle arcs having moderately different radii about an axis through 180°. Thus, the element has the form of one half of the radially inner half of a moderately thin-walled hollow torus, being cross-sectionally concave on its longitudinally convex outer face and cross-sectionally convex on its longitudinally concave inner face. The element is constructed to provide nesting or interlocked relationships with one or more other elements.

The original U-shaped “Original” Saddle packing element was disclosed by Leva who designed this packing element to allow individual saddles to nest together in three (3) major orientations (X, Y, Z), as shown in FIG. 20, when randomly poured into a containment vessel to create a bed of packing elements. Nesting verses not nesting, increases the number of pieces per unit volume, thereby increasing the geometric surface area per unit volume when compared to the state of the art packing at that time (i.e. a cylindrical ring with a length=diameter, a.k.a. Raschig Ring).

Another tower packing element for use in randomly packed beds of mass transfer towers and in randomly packed beds for use in heat sink applications is disclosed in U.S. Pat. No. 6,547,222 to Blischak et al., which U.S. patent is fully incorporated by reference herein. The packing element is provided with a W-shaped transverse cross-sectional base profile (i.e. “W” Saddle).

The Blischak et al. packing element comprises a saddle shape defined by a segment of a toroid generated by rotating a generally w-shaped curve about an axis of the saddle shape that is coplanar with and spaced from the curve. Another way of describing the shape of the element is that of a segment of a hollow torus that has a fold creating a “w” shaped cross section perpendicular to the rotation of the torus.

The Blischak et al. packing element includes a central ridge, a pair of grooves, and a pair of edge ridges. This “W” Saddle is shown in FIG. 20.

The “W” Saddle provides more geometric surface area per piece as compared to the “Original” Saddle disclosed by Leva, and limits nesting in one orientation.

There is always a need for an improved packing element, which minimizes pressure drop per unit length of packed bed in the flow direction, and maximizes the amount of surface area per flow length of packed bed in the flow direction. Further, there exists a need for a packing element that reduces or eliminates various modes of nesting between packing elements.

The packing element described below can significantly increase geometric surface area per piece as compared to the “Original” Saddle packing element disclosed by Leva.

Further, for the same geometric surface area per unit volume, the void per unit volume is similar between the “Original” Saddle”, the “W” Saddle, and the packing element described below. However, in the packing element described below, the individual void opening that make up the total void can be larger as compared to the “Original” Saddle and the “W” Saddle due to larger piece size and less pieces per volume. This may be beneficial in applications where a particulate laden fluid is flowing through the packed bed.

### SUMMARY OF THE INVENTION

A first object is to provide an improved packing element.

A second object is to provide an improved saddle-shaped packing element.

A third object is to provide a rim-shaped packing element.

A fourth object is to provide a combined saddle-shaped and rim-shaped packing element.

A fifth object is to provide a packing element comprising or consisting of a rim-shaped body comprising at least one lateral flange rim portion or a pair of lateral flange rim portions.

A sixth object is to provide a packing element comprising or consisting of at least a segment of a rim-shaped body comprising a pair of lateral rim flange portions.

A seventh object is to provide a packing element comprising or consisting of at least a segment of a rim-shaped packing element comprising a pair of lateral flange rim portions, the lateral flange rim portions being circular-shaped body portions.

An eighth object is to provide a packing element comprising or consisting of at least a segment of a rim-shaped body comprising a pair of lateral flange rim portions, the lateral flange rim portions being cylindrical-shaped body portions.

A ninth object is to provide a packing element comprising or consisting of at least a segment of a rim-shaped body comprising a pair of lateral flange rim portions, wherein a profile of a transverse cross-section of the rim-shaped body comprises a center rim portion connecting together the lateral flange rim portions.

A tenth object is to provide a packing element comprising or consisting of at least a segment of a rim-shaped body comprising a pair of cylindrical-shaped lateral flange rim portions, wherein a profile of a transverse cross-section of the rim-shaped body comprises a center rim portion connecting together the lateral flange rim portions.

An eleventh object is to provide a packing element comprising or consisting of at least a segment of a rim-shaped body comprising a pair of lateral flange rim portions, and at least one flange extending from the rim-shaped body.

A twelfth object is to provide a packing element comprising or consisting of at least a segment of a rim-shaped body comprising a pair of lateral flange rim portions, and at least one flange extending outwardly from the rim-shaped body.

A thirteenth object is to provide a packing element comprising or consisting of at least a segment of a rim-shaped body comprising a pair of lateral flange rim portions, and at least one flange extending inwardly from the rim-shaped body.

A fourteenth object is to provide a packing element comprising or consisting of at least a segment of a rim-shaped body comprising a pair of lateral flange rim portions, at least one flange extending outwardly from the rim-shaped body, and at least one flange extending inwardly from the rim-shaped body.

A fifteenth object is to provide a packing element comprising or consisting of at least a segment of a rim-shaped body comprising a pair of lateral flange rim portions, and a pair of off center flanges extending inwardly from the rim-shaped body.

A sixteenth object is to provide a packing element comprising or consisting of at least a segment of a rim-shaped body comprising a pair of lateral flange rim portions, and a center flange extending outwardly from the rim-shaped body, and a pair of off center flanges extending inwardly from the rim-shaped body, the pair of off center flanges extending inwardly from a transverse cross-sectional profile of the rim-shaped body.

A seventeenth object is to provide a packing element comprising or consisting of at least a segment of a rim-shaped body comprising a pair of opposed flange rim portions, at least one flange extending outwardly from the rim-shaped body, and a pair of off center flanges extending inwardly from the rim-shaped body

A eighteenth object is to provide a packing element comprising or consisting of at least a segment of a rim-shaped body comprising a pair of lateral flange rim portions, and a pair of off center flanges extending inwardly from the rim-shaped body, the pair of off center flanges extending inwardly at an angle relative to a center vertical axis of the transverse cross-sectional profile of the rim-shaped body.

A nineteenth object is to provide a packing element comprising or consisting of at least a segment of a rim-shaped body comprising a pair of lateral flange rim portions, wherein a transverse base profile of the rim-shaped body comprises a substantially uniform thickness edge to edge.

A twentieth object is to provide a packing element comprising or consisting of at least a segment of a rim-shaped body comprising a pair of lateral flange rim portions, wherein the transverse base profile comprises a center U-shaped profile portion connecting together a pair of outer flange profile portions.

A twenty first object is to provide a packing element comprising or consisting of at least a segment of a rim-shaped body comprising a pair of lateral flange rim portions, wherein the transverse base profile comprises a center V-shaped profile portion connecting together a profile of the pair of lateral flange rim portions.

A twenty second object is to provide a packing element comprising or consisting of at least a segment of a rim-shaped body comprising a pair of lateral flange rim portions, wherein the transverse base profile comprises a center U-shaped profile portion connecting together a profile of the pair of lateral flange rim portions, wherein the profile of the pair of lateral flange rim portions comprises reverse U-shaped profile portions connected together by and relative to the center U-shaped portion.

A twenty third object is to provide a packing element comprising or consisting of at least a segment of a rim-shaped body comprising a pair of lateral flange rim portions, wherein a transverse base profile of the rim-shaped body comprises a substantially uniform thickness edge to edge, wherein the transverse base profile of the rim-shaped body comprises a pair of off center bulging base profile portions located along a U-shaped center profile portion.

A twenty fourth object is to provide a packing element comprising or consisting of at least a segment of a rim-shaped body comprising a pair of lateral flange rim portions, wherein a transverse base profile of the rim-shaped body comprises a substantially uniform thickness edge to edge, wherein the transverse base profile of the rim-shaped body comprises a pair of off center bulging base profile portions located along a U-shaped center profile portion, and further comprising a center flange profile portion extending outwardly from the U-shaped profile portion and a pair of off center flange profile portions extending inwardly from the U-shaped profile portion.

A twenty fifth object is to provide a packing element comprising or consisting of at least a segment of a rim-shaped body comprising a pair of lateral flange rim portions, wherein a transverse base profile of the rim-shaped body comprises a substantially uniform thickness edge to edge, wherein the transverse base profile of the rim-shaped body comprises a pair of off center bulging base profile portions located along a U-shaped center profile portion, a center flange profile portion extending outwardly from the U-shaped profile portion, and a pair of off center flange profile portions extending inwardly from the U-shaped profile portion, wherein the off center bulging base profile portions are located adjacent and further off center relative to the pair of off center flange profile portions.

A twenty sixth object is to provide a packing element comprising or consisting of at least a segment of a rim-shaped body comprising a pair of lateral flange rim portions, wherein a transverse base profile of the rim-shaped body comprises a substantially uniform thickness edge to edge, wherein the transverse base profile of the rim-shaped body comprises a pair of bulging edge portions.

A twenty seventh object is to provide a packing element comprising or consisting of at least a segment of a rim-shaped body comprising a pair of lateral flange rim portions, wherein a transverse base profile of the rim-shaped body comprises a substantially uniform thickness edge to edge, wherein the transverse base profile of the rim-shaped body comprises a pair of off center bulging base profile portions located along a U-shaped center profile portion, wherein the transverse base profile of the rim-shaped body comprises a pair of bulging edge portions.

A twenty eighth object is to provide a packing element comprising or consisting of at least a segment of a rim-shaped body comprising a pair of lateral flange rim portions, and a pair of off center flanges extending inwardly from an inner surface of the rim-shaped body, wherein the center flange and off center flanges define a Y-shaped center profile portion of a transverse cross-sectional profile of the rim-shaped body.

A twenty ninth object is to provide a packing element comprising or consisting of at least a segment of a rim-shaped tower packing element comprising a pair of lateral flange rim portions, wherein a size of an angle A of the section of the rim-shaped body is in a range of 30° to 270°.

A thirtieth object is to provide a packing element comprising or consisting of at least a segment of a rim-shaped body comprising a pair of lateral flange rim portions, wherein a size of an angle of the section of the rim-shaped body is in a range of 170° to 190°.

A thirty first object is to provide a packing element comprising or consisting of at least a segment of a rim-shaped body comprising a pair of lateral flange rim portions, wherein a radius R of the rim-shaped body is in a range of 0.5 to 4.0 times a width W of the rim-shaped body.

A thirty second object is to provide a packing element comprising or consisting of at least a segment of a rim-shaped body comprising a pair of lateral flange rim portions, wherein a radius R of the rim-shaped body is in a range of 0.75 to 4.0 times a width W of the rim-shaped body.

A thirty third object is to provide a packing element comprising or consisting of at least a segment of a rim-shaped body comprising a pair of lateral flange rim portions, wherein a width G of each rim flange portion is in a range of 0.1 to 0.4 times a width W of the rim-shaped body.

A thirty fourth object is to provide a packing element comprising or consisting of at least a segment of a rim-shaped body comprising a pair of lateral flange rim portions, wherein a width W_{f} of each rim flange portion is in a range of 0.15 to 0.3 times a width W of the rim-shaped body.

A thirty fifth object is to provide a packing element comprising or consisting of at least a segment of a rim-shaped body comprising a pair of lateral flange rim flange portions, wherein a differential radial length between an outer radius Rₒ and an inner radius Rᵢ (i.e. outer radius Rₒ minus inner radius Rᵢ) of the rim-shaped body is in a range of 0.9 times Rₒ to 0.1 times the outer Rₒ minus the thickness T of the rim-shaped body (math, Rₒ−Rᵢ=0.9×R to 0.1×(R−T).

A thirty sixth object is to provide a packing element comprising or consisting of at least a segment of a rim-shaped body comprising a pair of lateral flange rim portions, wherein the differential radial length (Rₒ minus Rᵢ) of the rim-shaped body is equal to 0.3 to 0.6 times Rₒ (math, Rₒ<Rᵢ=0.3×Rₒ to 0.6×Rₒ)

A thirty seventh object is to provide a packing element comprising or consisting of at least a segment of a rim-shaped body comprising a pair of lateral flange rim portions, and at least one through hole in the rim-shaped body.

A thirty eighth object is to provide a packing element comprising or consisting of at least a segment of a rim-shaped body comprising a pair of lateral flange rim portions, and at least one through hole in the rim-shaped body, wherein the at least one through hole is centered in the rim-shaped body.

A thirty ninth object is to provide a packing element comprising or consisting of at least a segment of a rim-shaped body comprising a pair of lateral flange rim portions, and at least one through hole in the rim-shaped body, wherein the at least one through hole is centered in the rim-shaped body, wherein the at least one through hole is off center in the rim-shaped body.

A fortieth object is to provide a packing element comprising or consisting of at least a segment of a rim-shaped body comprising a pair of lateral flange rim portions, and at least one through hole in the rim-shaped body, wherein the at least one through hole is at least partially located on at least one of the rim flange portions.

A forty first object is a fluid treatment process comprising or consisting of reducing nesting between packing elements in a fluid bed or column.

A forty second object is a fluid treatment process comprising or consisting of reducing nesting between packing elements in a fluid bed or column by configuring the packing element to reduce or eliminate nesting between adjacent packing elements packed in the fluid bed or column.

A forty third object is a fluid treatment process comprising or consisting of reducing nesting between packing elements in a fluid bed or column by configuring the packing elements to minimize or eliminate one packing element entering into an interior space of an adjacent packing element in the fluid bed or column.

A forty fourth object is a fluid treatment process comprising or consisting of reducing nesting between packing elements in a fluid bed or column by configuring the packing elements to minimize or eliminate one packing element entering into an interior space of an adjacent packing element in the fluid bed or column, the configuration comprising providing the packing elements with one or more lateral flange rim portions.

A forty fifth object is a fluid treatment process comprising or consisting of reducing nesting between packing elements in a fluid bed or column by configuring the packing elements to minimize or eliminate one packing element entering into an interior space of an adjacent packing element in the fluid bed or column, the configuration comprising providing the packing elements with at least one lateral flange rim portions and one or more outwardly extending flange portions.

A forty sixth object is a fluid treatment process comprising or consisting of reducing nesting between packing elements in a fluid bed or column by configuring the packing elements to minimize or eliminate one packing element entering into an interior space of an adjacent packing element in the fluid bed or column, the configuration comprising providing the packing elements with at least one lateral flange rim portion and one or more inwardly extending flange portions.

A forty seventh object is a fluid treatment process comprising or consisting of reducing nesting between packing elements in a fluid bed or column by configuring the packing elements to minimize or eliminate one packing element entering into an interior space of an adjacent packing element in the fluid bed or column, the configuration comprising providing the packing elements with at least one lateral flange rim portions, one or more outwardly extending flange portions, and one or more inwardly extending flange portions.

A forty eighth object is a fluid treatment process comprising or consisting of reducing nesting between packing elements in a fluid bed or column by configuring the packing elements to minimize or eliminate one packing element entering into an interior space of an adjacent packing element in the fluid bed or column, the configuration comprising providing the packing elements with a pair of lateral flange rim portions and one or more inwardly extending flange portions.

A forty ninth object is a fluid treatment process comprising or consisting of reducing nesting between packing elements in a fluid bed or column by configuring the packing elements to minimize or eliminate one packing element entering into an interior space of an adjacent packing element in the fluid bed or column, the configuration comprising providing the packing elements with one or more side flange rim portions, one or more outwardly extending flange portions, and one or more inwardly extending flange portions.

A fiftieth object is to provide a packing element comprising or consisting of at least a segment of a rim-shaped body comprising a pair of lateral flange rim portions extending perpendicular from a side of a center rim portion of the packing element.

A fifty first object is to provide a packing element comprising or consisting of at least a segment of a rim-shaped body comprising a pair of lateral flange rim portions extending perpendicular from a side of a center rim portion of the packing element, the width of each lateral flange rim portion being at least one-quarter a width of the packing element.

A fifty second object is to provide a packing element comprising or consisting of at least a segment of a rim-shaped body comprising a pair of lateral flange rim portions extending perpendicular from a side of a center rim portion of the packing element, and a pair of flanges inwardly extending from the rim-shaped body, the lateral flange rim portions and inwardly extending flanges having ends defining the sides of the packing element.

The packing element can be a packing element for use in a process vessel such as a column, chamber, or tower for mass transfer or heat transfer applications. The packing element can be a rim-shaped packing element, and can also be a segment of a rim-shaped packing element (i.e. combined rim-shaped and saddle-shaped element). The size of the angle A of the segment can be 30° to 270°, or can be 170° to 190°.

The packing element can have a general shape the same as or similar to a toroid (e.g. torus). The packing element can be a segment of the toroidal-shaped packing element, or otherwise a saddle-shaped packing element. The rim-shaped packing element can include at least one lateral (side) flange rim portion, or a pair of lateral (side) flange rim portions connected together by a center rim portion. For example, a pair of lateral (side) flange rim portions extend away laterally (i.e. sideways) from the center rim portion. The lateral flange rim portion or portions can have a width being a portion of the width of the packing element. For example, the lateral flange rim portion(s) can have a width at least one-quarter the width of the packing element, or can be at least one-third of the width of the packing element.

The center rim portion can be U-shaped, V-shaped, or polygonal shaped. The side flange rim portion(s) and center rim portion can be shaped to increase surface area.

The packing element can be configured to allow nesting of packing elements together, or can be configured to substantially prevent or eliminate nesting of packing elements together. Nesting typically increases the differential pressure per column length to provide adequate flow through the column. Further, increased differential flow pressure increases energy consumption. The nesting or not nesting is a way to adjust surface area and void for a particular application. In some applications that may require maximum surface area, a lower pressure drop may not be of concern.

The rim-shaped packing element can be configured to prevent nesting while increasing the surface area of the packing element. This arrangement increases the efficiency of the fluid bed or column. The rim-shaped packing element can comprise one or more lateral flange rim portions (e.g. a pair of lateral flange rim portions connected together by center rim portion). For example, the lateral (side) flange rim portion can be oriented and extend outward laterally from a side of a center rim portion of the packing element. The lateral flange rim portion(s) can be configured to prevent nesting.

The packing element can include a U-shaped center rim portion connecting together at least one lateral flange rim portion (e.g. pair of lateral flange rim portions) defining a modified U-shaped transverse cross-sectional profile of the packing element. In other words, the U-shaped profile of the U-shaped center rim portion reverses at the transition point with the lateral flange rim portions.

The pair of lateral flange rim portions acts like “wings”. The “wings” can be the same size and symmetrical, or can be different sizes (i.e. dimensions) and/or can be non-symmetrical.

In addition, the packing element can be provided with one or more openings (e.g. through holes) or notches (e.g. edge or surface notches) through the packing element to lower the resistance to fluid flow. For example, one or more openings and/or notches can be provided in the center rim portion and/or side flange rim portions. The openings and/or notches can be configured so as to minimize structurally weakening the packing element.

The transverse cross-sectional profile of the packing element can have a uniform thickness or varying thickness. For example, the profile can have a uniform thickness with one or more bulging portions to increase the thickness and strength of the packing element at particular locations requiring additional strength.

The packing element can comprise one or more outwardly and/or inwardly extending flange portions. For example, the packing element comprises an outwardly extending center flange portion. The center flange portion can be configured to avoid nesting between the U-shaped center rim portion. The packing element, alternatively or in addition, can include one or more inwardly extending flange portions. For example, the packing element is provided with a pair of inwardly extending off center flange portions. The off center flange portions can be configured to avoid nesting of another packing element in a center space or hole of the packing element.

The center outwardly extending flange portion can be aligned with a vertical axis of a transverse cross-section of the packing element, and the pair of off center inwardly extending flange portions can be aligned at an angle (e.g. 50°) from the vertical axis.

The center outwardly extending flange portion in combination with the off center inwardly extending flange portions can form a Y-shaped portion of the transverse cross-sectional profile of the packing element.

The inwardly extending flange portions can be set at an angle relative to a center vertical axis of the packing element and extend from the center rim portion to the sides of the packing element. In addition, the ends of the lateral flange rim portions and inwardly extending flange portions can define the sides of the packing element.

The outer diameter Dₒ of the packing element can be 0.5 inches to 7 inches. The outer radius Rₒ of the packing element can equal 0.5 to 4.0 times the width W of the packing element (math, Rₒ=0.5×W to 4.0×W), or the outer radius Rₒ of the packing element can be 0.75 to 1.25 times the width W of the packing element (math, Rₒ=0.75×W to 1.25×W). The thickness T of the packing element can be 0.05 to 0.2 times the width W of the packing element (math, T=0.05×W to 0.2×W). The width W_{f} of each side flange rim portion can be 0.1 to 0.4 times the width W of the packing element (math, W_{f}=0.1×W to 0.4×W), or the width W_{f} of each side flange rim portion can be 0.15 to 0.30 times the width W (math, W_{f}=0.15×W to 0.30×W). Further, the differential radial length between the outer radius Rₒ minus the inner radius Rᵢ (i.e. Rₒ−Rᵢ) can be 0.9 times Rₒ to 0.1 times the outer radius Rₒ minus the thickness T of the packing element (math, Rₒ−Rᵢ=0.9×Rₒ to 0.1×(Rₒ−T), or the differential radial length between the outer radius Rₒ minus the inner radius Rᵢ can be 0.5 to 0.8 times the outer radius Rₒ (math, Rₒ−Rᵢ=0.5×Rₒ to 0.8×Rₒ).

The packing element can be made of an extruded material such as natural clay, synthetic clay, zeolites, cordierites, aluminas, zirconia, silica, or mixtures thereof. The clay material is extruded through a die, and then curls into a toroidal-shaped body as it exits the die. When the toroidal-shaped body reaches its specified length, a section is cut from the clay material being extruded. The section of the toroidal-shaped body is then fired in a kiln or oven to turn the clay material into hardened ceramic material.

The packing elements can be “randomly” packed, and/or “dumped” into a processing tower to make a packed fluid bed or column. Then, gas or fluid to be treated is pumped under pressure through the packed column to treat the gas or fluid. The packed column can be used for decomposition, absorption, distillation, and scrubbing of chemicals. For example, polluted or contaminated air is treated by flowing under pressure and heat through the packed column to reduce or eliminate the pollutants or contaminates contained in the gas or fluid.

The packed column can be made with the same size and shape packing elements, or can be mixed with different size and shape packing elements or different types of packing elements. The column can be packed with different layers of packing elements or combinations of packing elements to achieve a desired processing arrangement.

### BRIEF DESCRIPTION OF DRAWINGS

FIG. 1 is a perspective view of a first packing element.

FIG. 2. is a side elevational view of the first packing element shown in FIG. 1.

FIG. 3 is an open end elevational view of the first packing element shown in FIG. 1.

FIG. 4 is a closed end elevational view of the first packing element shown in FIG. 1.

FIG. 5 is a top planar view of the first packing element shown in FIG. 1.

FIG. 6 is a bottom planar view of the first packing element shown in FIG. 1.

FIG. 7 is a cross-sectional view of the first packing element, as indicated in FIG. 2.

FIG. 8 is an open end elevational view of a second packing element showing the basic shape or basic profile of a packing element.

FIG. 9 is an open end elevational view of a third packing element showing a V-shaped center rim portion.

FIG. 10 is an open end elevational view of a fourth packing element comprises holes and notches.

FIG. 11 is an open end elevational view of a fifth packing element comprising shorter off center inwardly extending protrusions.

FIG. 12 is an open end elevational view of a sixth packing element having a single outwardly extending center protrusion and a single inwardly extending center protrusion.

FIG. 13 is an open end elevational view of a seventh packing element comprising a single longer outwardly extending center protrusion and a pair of longer inwardly extending off center protrusions.

FIG. 14 is an open end elevational view of an eighth packing element comprising a single longer outwardly extending center protrusion, four (4) inwardly extending off center protrusions, and a center inwardly extending protrusion.

FIG. 15 is an open end elevational view of a ninth packing element comprising two (2) outwardly extending off center and one (1) outwardly extending center protrusions, and four (4) inwardly extending off center protrusions and one (1) inwardly extending center protrusion.

FIG. 16 is an open end elevational view of a tenth packing element comprising a pair of arc-shaped profile inwardly extending off center protrusions extending from a deeper U-shaped center rim portion.

FIG. 17 is an open end elevational view of an eleventh packing element comprising a pair of flat profiled lateral flange rim portions and a pair of off center inwardly extending protrusions extending from a deeper U-shaped center rim portion to a side of the packing element.

FIG. 18 is an open end elevational view of an eleventh packing element comprising a pair of flat profiled lateral flange rim portions and a pair of off center inwardly extending protrusions extending from a deeper U-shaped center rim portion to a side of the packing element.

FIG. 19 is an open end elevational view of an eleventh packing element comprising a pair of inwardly extending off center protrusions extending from a deeper U-shaped center rim portion.

FIG. 20 is an open end elevational view of the second packing element indicating the width W dimension of the packing element.

FIG. 21 is a side elevational view of the basic packing element shown in FIG. 20 indicating the outer radius Rₒ, inner radius R₁, and angle A of the packing element.

FIG. 22 is an open end elevational view of the basic packing element shown in FIG. 20 indicating the width W_{f} of the side flange rim portion, the height H of the profile shape, and thickness T of the packing element.

FIG. 23 is a diagrammatic view illustrating containing the protrusions of a packing element within an outside boundary limit.

FIGS. 24 a, b, and c is a nesting comparison along the X, Y, and Z orientations of “Original” Saddle disclosed in U.S. Pat. No. 2,639,909 to Leva, “W” Saddle disclosed in U.S. Pat. No. 6,547,222, and the “Current” Saddle.

### DETAILED DESCRIPTION

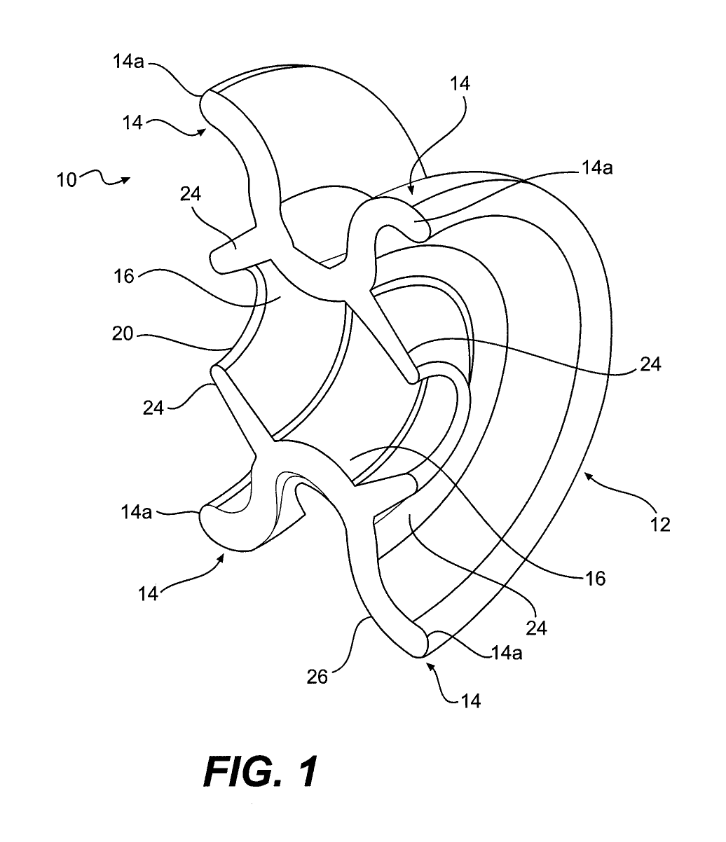

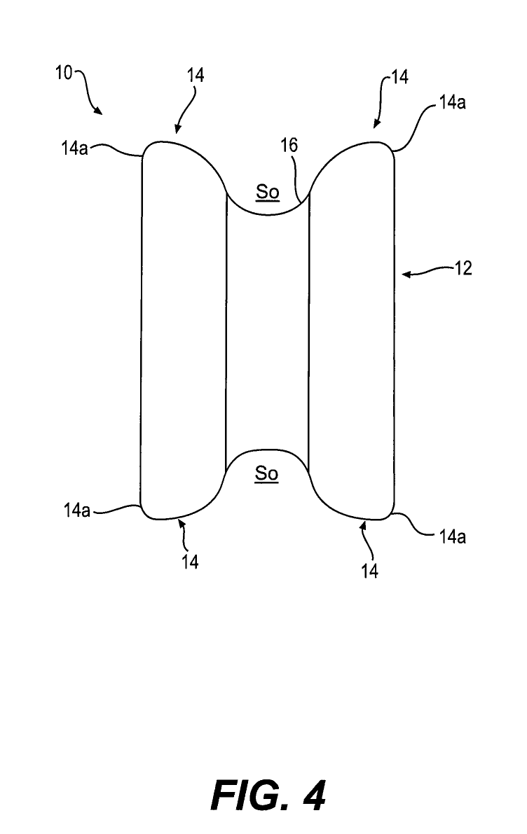

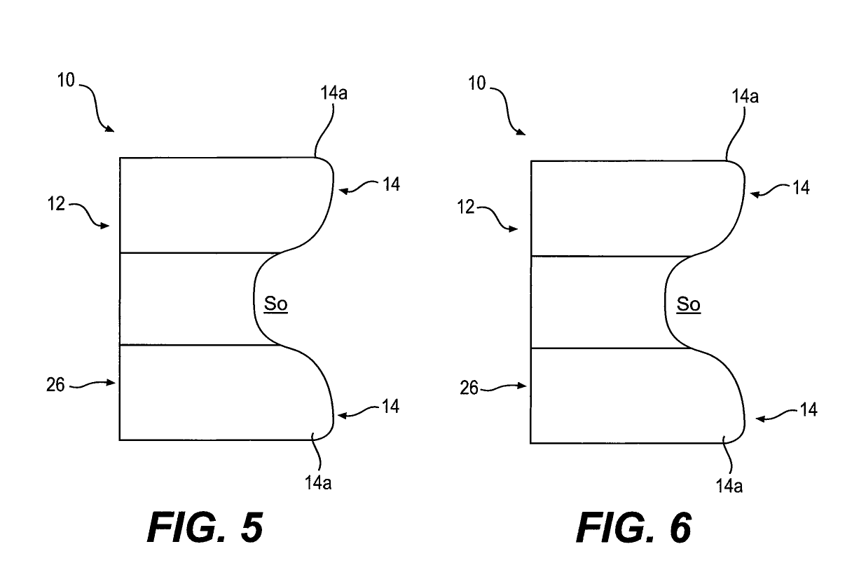

A first packing element 10 is shown in FIGS. 1-4. The first packing element 10 is a segment of a rim-shaped body 12 having a pair of lateral (side) flange rim portions 14, 14 connected to a center rim portion 16. The rim-shaped body 12 geometrically is a segment of a toroidal-shaped body resulting in a saddle-shaped packing element. The first packing element 10 is a modified U-shaped packing element.

The size and the shape of each lateral flange rim portion 14 is shown as being the same; however, the size and/or shape of one lateral flange rim portion 14 can be different from the other. In addition, one lateral flange rim portion 14 can be eliminated resulting in a modified packing element with only a single lateral flange rim portion 14.

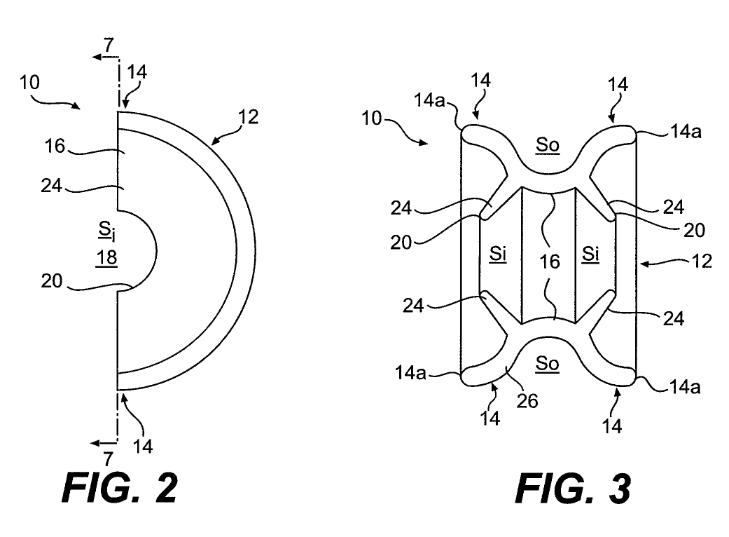

The lateral rim flange portions 14, 14 extend outwardly laterally (i.e. sideways) from the first packing element 10. Specifically, the end portions 14a, 14a of the lateral flange rim portions are oriented parallel relative to a center line of the first packing element (i.e. geometrical axis of rotation of plane containing geometrical figure for generating the toroidal-shaped body). Alternatively, the end portions 14a, 14a can be at an angle relative to the centerline (e.g. −45° to)+45°. Further, the first packing element 10 is provided with a center hole portion 18 shown as a half-circle in FIG. 2 defined by an inner rim edge 20.

The center rim portion 16 is shown as being U-shaped, and connecting the opposed lateral flange rim portions 14, 14 together. Alternatively, the center rim portion can have a different geometrical shape. The U-shaped center rim portion 16 together with the lateral flange rim portions 14, 14 result in a transverse cross-section base profile having a modified U-shaped configuration. Further, the basic profile has a substantially uniform thickness from edge-to-edge (i.e. edge of one lateral flange rim portion 14, along U-shaped center rim portion 16, to edge of the other lateral flange rim portion 14).

The first packing element 10 includes an outwardly extending center flange portion 22 and a pair of inwardly extending off center flange portions 24, 24. The flange portions 22, 24, 24 each have an inwardly tapering transverse cross-section profile from base to tip (e.g. triangular-shaped profile). The flange portions 22, 24, 24 together define a Y-shaped configuration of the three (3) protrusions of the first packing element 10.

The outwardly extending center flange portion 22 prevents another packing element from nesting with the first packing element 10 by entering into the outer space Sₒ located immediately outside the U-shaped center rim portion 16. The inwardly extending off center flange portions 24, 24 prevent another packing element from nesting with the first packing element by entering into the inner space Sᵢ inside the U-shaped center rim portion 16 (i.e. an end of another packing element cannot enter the center hole portion 18 (FIG. 2)).

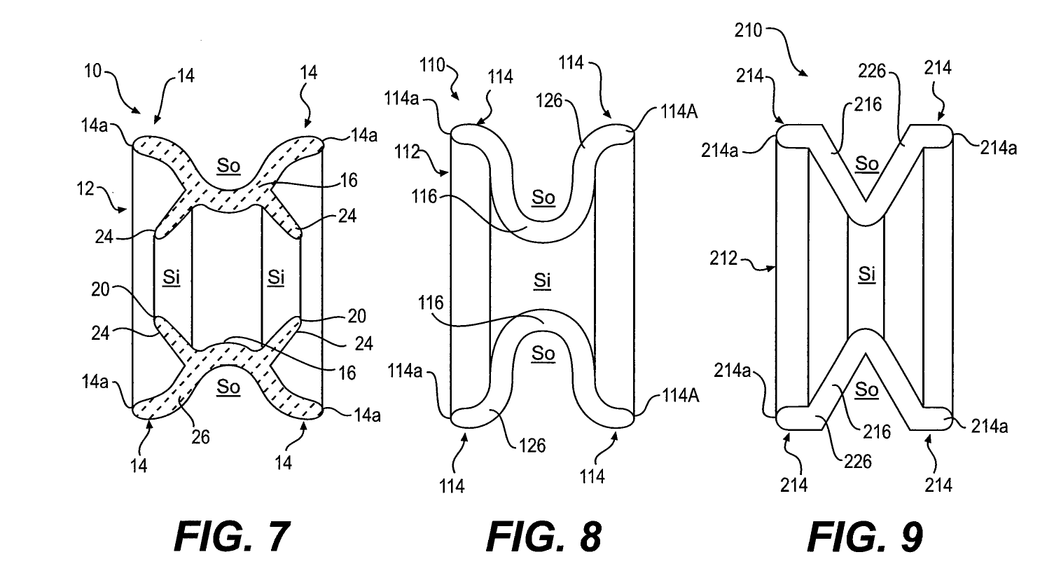

The first packing element 10 is provided with an end face 26 revealing the shape and detail of the edge profile of the first packing element 10. The edge profile 26 has the same shape and size as a transverse cross-sectional profile, as shown in FIG. 7.

A second packing element 110 is shown in FIG. 8. The second packing element 110 is a basic U-shaped packing element modified with lateral flange rim portions defining a modified U-shaped transverse cross-sectional profile packing element. The second packing element 110 is a segment of a rim-shaped body 112 having a pair of lateral flange rim portions 114, 114 connected to a U-shaped center rim portion 116. The second packing element 110 does not include any outwardly or inwardly protrusion portions like the first packing element 10, but instead has a uniform thickness basic transverse cross-sectional profile from edge to edge.

A third packing element 210 is shown in FIG. 9. The third packing element 210 is a basic V-shaped packing element modified with lateral flange rim portions defining a modified V-shaped packing element. The third packing element 210 is a segment of a rim-shaped body 212 having a pair of opposed lateral flange rim portions 214, 214 connected to a V-shaped center rim portion 216. The second packing element 210 does not include any outwardly or inwardly protrusion portions like the first packing element 10, but instead has a uniform thickness base and detail profile from edge to edge.

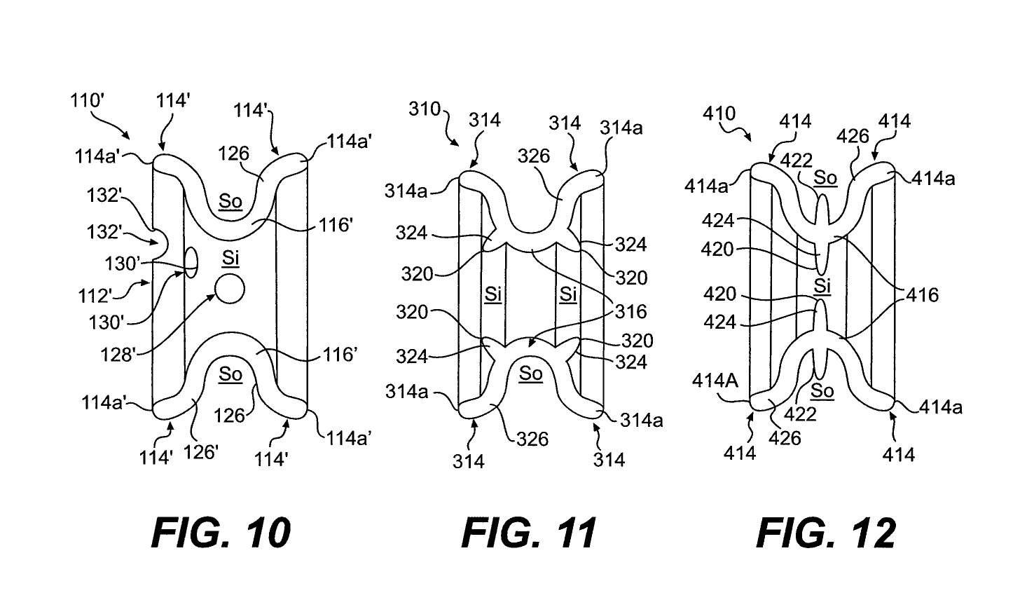

A modified version of the first packing element 110′ is shown in FIG. 10. The packing element 110′ is a basic U-shaped packing element modified with through holes 128′, 130′ and notches 132′. The packing element 110′ is a segment of a rim-shaped body 112′ having a pair of lateral flange rim portions 114′, 114′ connected to a U-shaped center rim portion 116′. The packing element 110′ does not include any outwardly or inwardly protrusions like the first packing element 10 (FIG. 1), but instead has a uniform thickness basic profile from edge to edge.

A fourth packing element 310 is shown in FIG. 11. The fourth packing element 310 is a modified U-shaped packing element. The fourth packing element 310 is a segment of a rim-shaped body 312 having a pair of lateral flange rim portions 314, 314 connected to a U-shaped center rim portion 316. The fourth packing element 310 includes two (2) inwardly extending protrusion portions 320, 320. The inwardly extending protrusion portions 320, 320 are shorter in length verses the inwardly extending protrusions 120, 120 of the first packing element 10 (FIG. 1). Further, any outwardly extending protrusion portion is eliminated compared to the packing element 10 shown in FIG. 1.

A fifth packing element 410 is shown in FIG. 12. The fifth packing element 410 is a modified U-shaped packing element. The fifth packing element 410 is a segment of a rim-shaped body 412 having a pair of lateral flange rim portions 414, 414 connected to a U-shaped center rim portion 416. The fifth packing element 410 includes two (2) inwardly extending protrusion portions 420, 420 and one (1) outwardly extending protrusion portion 422. The inwardly extending protrusion portions 420, 420 are shorter in length verses the inwardly extending protrusion portions 120, 120 of the first packing element 110 (FIG. 1).

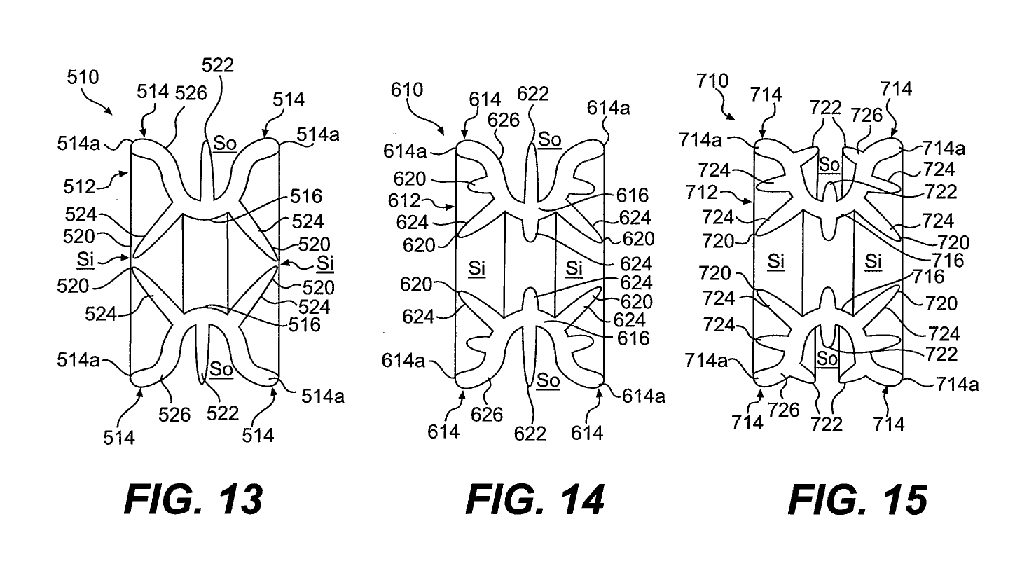

A sixth packing element 510 is shown in FIG. 13. The sixth packing element 510 is a modified U-shaped packing element. The fifth packing element 510 is a segment of a rim-shaped body 512 having a pair of lateral flange rim portions 514, 514 connected to a U-shaped center rim portion 516. The sixth packing element 510 includes two (2) inwardly extending protrusion portions 520, 520 and one (1) outwardly extending protrusion portion 522. The inwardly extending protrusion portions 520, 520 are longer in length verses the inwardly extending protrusion portions 20, 20 of the first packing element 10 (FIG. 1). Further, the outwardly extending protrusion portion 522 is longer in length verses the outwardly extending protrusion portion 22 of the first packing element 10 (FIG. 1).

A seventh packing element 610 is shown in FIG. 14. The seventh packing element 610 is a modified U-shaped packing element. The seventh packing element 610 is a segment of a rim-shaped body 612 having a pair of lateral flange rim portions 614, 614 connected to a U-shaped center rim portion 616. The seventh packing element 610 includes five (5) inwardly extending protrusion portions 620, 620, 620, 620, 620 and one (1) outwardly extending protrusion portion 422. The outwardly extending protrusion portion 622 is shorter in length verses the outwardly extending protrusion portion 22 of the first packing element 10 (FIG. 1).

An eighth packing element 710 is shown in FIG. 15. The eighth packing element 710 is a modified U-shaped packing element. The eighth packing element 710 is a segment of a rim-shaped body 712 having a pair of lateral flange rim portions 714, 714 connected to a U-shaped center rim portion 716. The eighth packing element 710 includes five (5) inwardly extending protrusion portions 724, 724, 724, 724, 724 and three (3) outwardly extending protrusion portions 722, 722, 722. The set of the inwardly extending protrusion portions 724, 724, 724, 724, 724 are shorter in length verses the inwardly extending protrusion portion 24 of the first packing element 10 (FIG. 1).

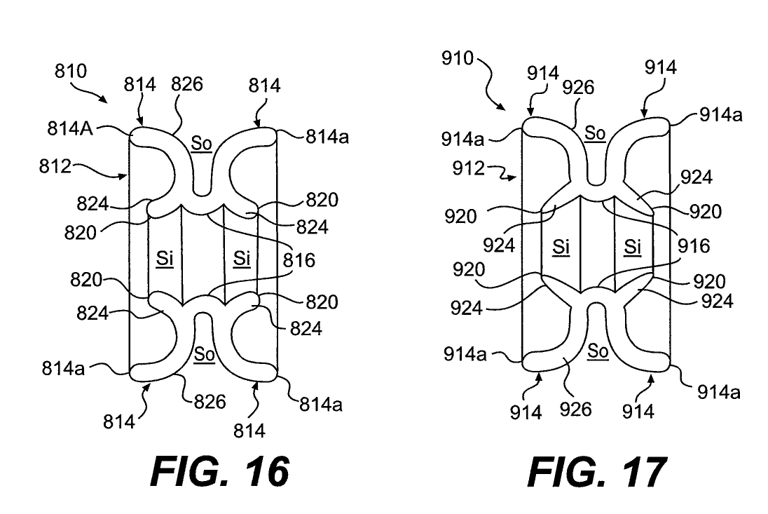

A ninth packing element 810 is shown in FIG. 16. The ninth packing element 810 is a modified deep U-shaped packing element. The ninth packing element 810 is a segment of a rim-shaped body 812 having a pair of lateral flange rim portions 814, 814 connected to a deep U-shaped center rim portion 816. The ninth packing element 810 includes a pair of arc-shaped inwardly extending off center protrusion portions 824, 824. The arc-shaped inwardly extending off center protrusion portions 824, 824 form U-shaped transverse cross-sectional portions with the pair of lateral flange rim portions 814, 814. The deep U-shaped center rim portion 816 provides more surface area verses the U-shaped center rim portion 16 of the first packing element 10 (FIG. 1).

A tenth packing element 910 is shown in FIG. 17. The tenth packing element 910 is a modified deep U-shaped packing element. The tenth packing element 910 is a segment of a rim-shaped body 912 having a pair of lateral flange rim portions 914, 914 connected to a deep U-shaped center rim portion 916. The tenth packing element 910 includes a pair of inwardly extending off center protrusion portions 924, 924. The inwardly extending off center protrusion portions 924, 924 form U-shaped transverse cross-sectional portions with the pair of lateral flange rim portions 914, 914. The deep U-shaped center rim portion 916 provides more surface area verses the U-shaped center rim portion 16 of the first packing element 10 (FIG. 1).

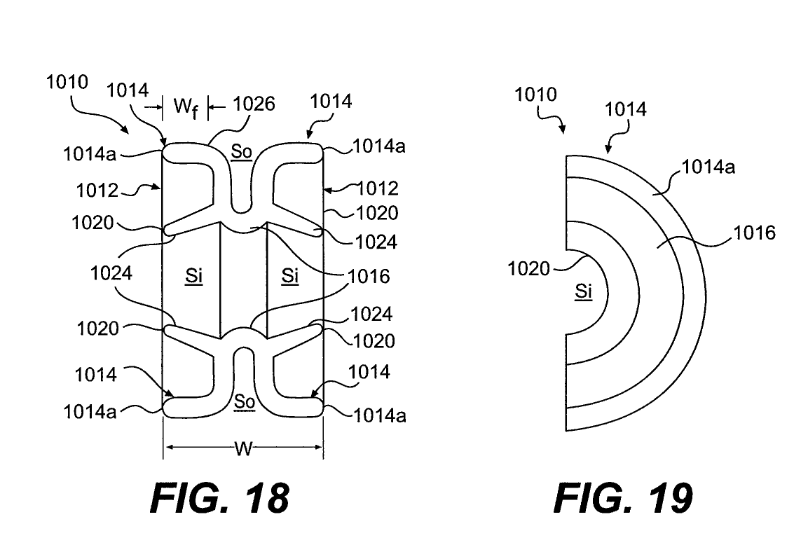

An eleventh packing element 1010 is shown in FIGS. 18 and 19. The eleventh packing element 1010 is a modified deep U-shaped packing element. The eleventh packing element 1010 is a segment of a rim-shaped body 1012 having a pair of lateral flange rim portions 1014, 1014 connected to a deep U-shaped center rim portion 1016. The eleventh packing element 1010 includes a pair of off center inwardly extending protrusion portions 1024, 1024 extending from the U-shaped center rim portion 0116 to the sides 1012, 1012 of the packing element 1010. The deep U-shaped center rim portion 1016 provides more surface area verses the U-shaped center rim portion 16 of the first packing element 10 (FIG. 1). The lateral flange rim portions 1014, 1014 have a flat transverse cross-sectional profile, as shown in FIG. 18. The width W of the flat profiled lateral rim portions 1014, 1014 can have a width W_{f} of at least one-quarter of the width W of the packing element 1010, or can have a width W_{f} of at least one-third of the width W of the packing element 1010.

Increasing the number of outwardly extending protrusion portions and inwardly extending protrusion portions increases the amount of surface area of the various packing elements and increases efficiency.

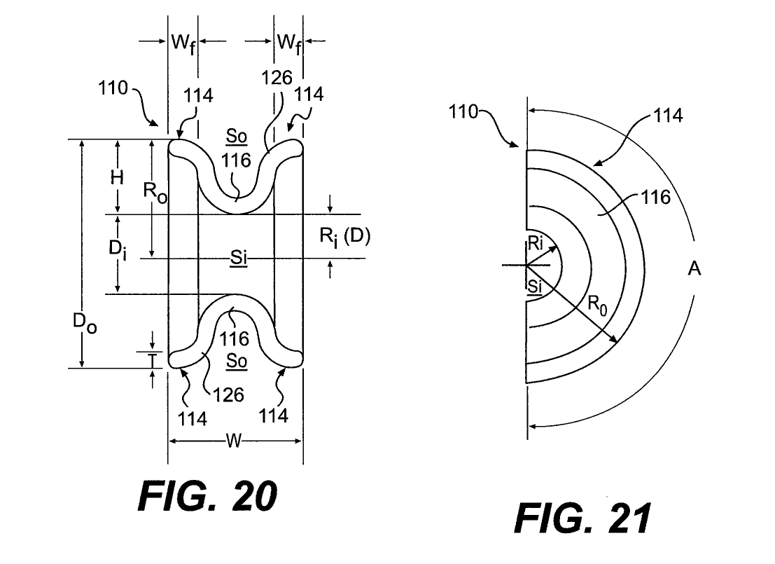

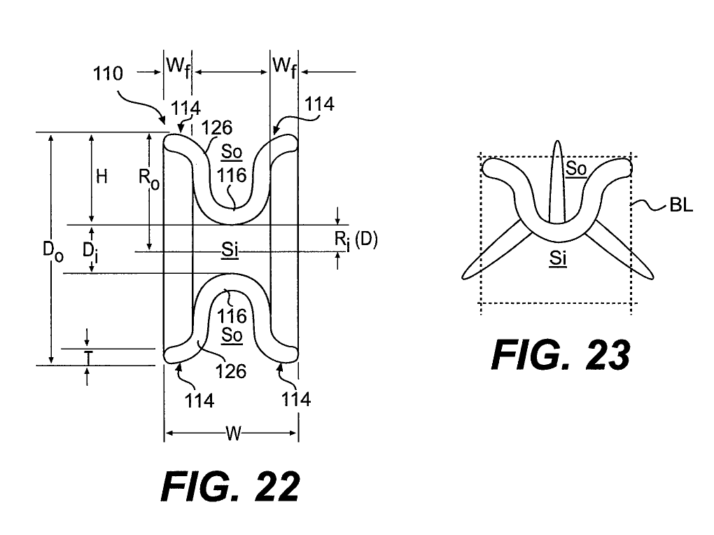

The details of the configuration of the second packing element 110 is shown in FIGS. 20-23. These details can also apply to the other packing elements disclosed herein.

The width W of the packing element 110 is shown in FIG. 20. The inner radius Rᵢ, outer radius Rₒ, and angle A of the packing element 110 is shown in FIG. 21. The angle A of packing element 110 can be 30° to 270°. The angle A of the packing element 110 can be 170° to 190°.

The width W_{f} of the side flange rim portions 114, 114 can be 0.1 times the width W of the packing element 110 to 0.4 times the width W of the packing element 110 (i.e. 0.1×W to 4.0×W).

The differential radial distance between the outer radius Rₒ and the inner radius Rᵢ (i.e. Rₒ−Rᵢ) of the packing element 110 can be 0.9 times the outer radius Rₒ (i.e. 0.9×Rₒ) of the packing element 110 to 0.1 times the differential between the outer radius Rₒ of the packing element 110 minus the thickness T of the side flange rim portion 114 (math, Rₒ−Rᵢ=0.9×Rₒ to 0.1×(Rₒ−T)). Alternatively, the differential radial distance between the outer radius Rₒ and the inner radius Rᵢ (i.e. Rₒ−Rᵢ) of the packing element 110 can be 0.3 to 0.6 times the outer radius Rₒ (math, Rₒ−Rᵢ=0.3×Rₒ to 0.6×Rᵢ).

The thickness T of the side flange rim portion 114 can be 0.05 times the width W of the packing element 110 to 0.2 times the width W of the packing element (math, 0.05×W to 0.2×W).

To prevent nesting of one packing element inside another packing element, assuming the same size and shape packing elements, both the width W and height H of the packing elements must be greater than the inner radius Rᵢ of the packing elements to prevent ingress into the inner space Sᵢ. Specifically, the end face 126 of one packing element must be configured (i.e. dimensioned and/or shaped) so as to not enter within the inner space Sᵢ of another packing element. The addition of inwardly extending flange portions 24, 24 in the first packing element 10 is shown in FIG. 1, compared to the basic configuration of the second packing element 110 shown in FIG. 8, results in a configuration that prevents nesting within the inner space Sᵢ.

To prevent nesting of one packing element within the outer space Sₒ (FIG. 1) of another packing element, the addition of an outwardly extending flange portion 422 (FIG. 12), 522 (FIG. 13), 622 (FIG. 14), and 722 (FIG. 15), compared to the basic configuration of the second packing element 110 shown in FIG. 8, results in a configuration that prevents nesting within the outer space Sₒ (FIG. 3).

The length of the protrusions can be limited to a particular size and or shape. For example, the primary edge profile including the outwardly extending and inwardly extending protrusions can be configured to fit within a rectangular outside boundary limit BL, as shown in FIG. 23. The protrusions are shown extending beyond the outside boundary limit BL, and the can extend beyond, but it is desirable that they remaining within the outside boundary limit BL. Otherwise, the protrusions becomes structurally weak and subject to damage or breakage.

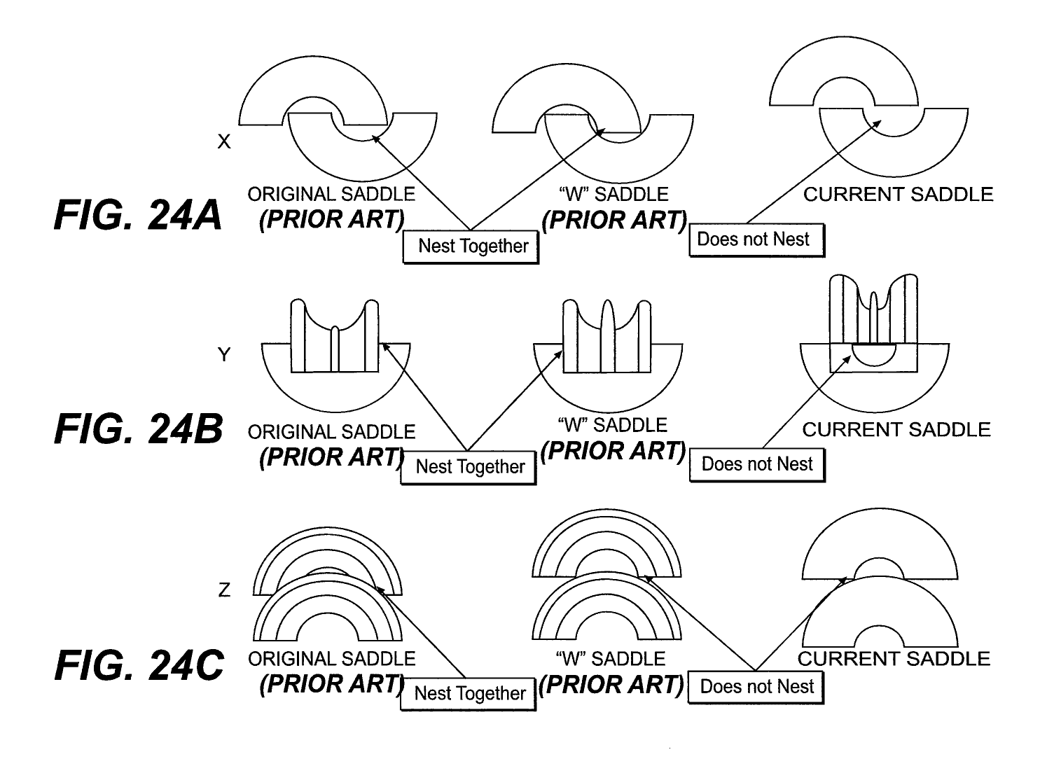

As shown in FIGS. 24 a, b, and, the “Current” Saddle does not nest in any of the X, Y, and Z orientations, which improves fluid to flow through a bed made of the “Current” Saddles with reduced pressure compared to the “Original” Saddle and ‘W’ Saddle resulting in operating energy savings.

### Process

The process of treating fluid comprises passing fluid through a fluid bed or column using one or more of the packing element described above and shown in the drawings. These packing elements provide increased surface area and reduce or eliminate nesting to enhance fluid flow through the fluid bed or column with reduced pressure differential while decreasing energy consumption.

We claim:

1. A ceramic tower saddle packing element, comprising:
at least a segment of a rim-shaped body comprising a pair of opposed lateral flange rim portions.

2. The packing element according to claim 1, wherein the lateral flange rim portions are segments of a curve.

3. The packing element according to claim 2, wherein the lateral flange rim portions are segments of a cylinder.

4. The packing element according to claim 1, wherein the lateral flange rim portions have a flat transverse cross-sectional profile.

5. The packing element according to claim 4, wherein the lateral flange rim portions have a width of at least one-quarter of a width of the packing element.

6. The packing element according to claim 1, wherein a profile of a transverse cross-section of the rim-shaped body comprises a center rim portion connecting together the lateral flange rim portions.

7. The packing element according to claim 6, wherein a profile of a transverse cross-section of the center rim portion is U-shaped.

8. The packing element according to claim 6, wherein the lateral flange rim portions are segments of a cylinder.

9. The packing element according to 1, further comprising a center flange portion extending outwardly from an outer surface of the rim-shaped body.

10. The packing element according to claim 9, wherein the center flange portion comprises a triangular-shaped transverse cross-sectional profile.

11. The packing element according to claim 1, further comprising a pair of off center flange portions extending inwardly from the rim-shaped body.

12. The packing element according to claim 9, further comprising a pair of off center flange portions extending inwardly from the rim-shaped body.

13. The packing element according to claim 12, wherein the pair of off center flange portions each comprise a triangular-shaped transverse cross-sectional profile.

14. The packing element according to claim 12, wherein the center flange and the off center flange portions comprise triangular-shaped portions of a transverse cross-sectional profile of the rim-shaped body.

15. The packing element according to claim 12, wherein the pair of off center flanges extend inwardly at an angle relative to a center vertical axis of the transverse cross-sectional profile of the rim-shaped body.

16. The packing element according to claim 1, wherein a transverse base profile of the rim-shaped body comprises a substantially uniform thickness edge to edge.

17. The packing element according to claim 1, wherein the transverse base profile comprises a center U-shaped profile portion connecting together a pair of outer flange profile portions.

18. The packing element according to claim 1, wherein the transverse base profile comprises a center V-shaped profile portion connecting together a pair of outer flange profile portions.

19. The packing element according to claim 17, wherein the outer flange profile portions comprise reverse U-shaped profile portions connected together by and relative to the center U-shaped portion.

20. A packing element according to claim 16, wherein the transverse base profile of the rim-shaped body comprises a pair of off center bulging base profile portions located along a U-shaped center profile portion to increase a bending strength of the packing element.

21. A packing element according to claim 20, further comprising a center flange profile portion extending outwardly from the U-shaped profile portion and a pair of off center flange profile portions extending inwardly from the U-shaped profile portion

22. A packing element according to claim 21, wherein the off center bulging base profile portions are located adjacent and further off center relative to the pair of off center flange profile portions.

23. A packing element according to claim 16, wherein the transverse base profile of the rim-shaped body comprises a pair of bulging edge portions.

24. The packing element according to claim 12, wherein the center flange and off center flanges define a Y-shaped center profile portion of a transverse cross-sectional profile of the rim-shaped body.

25. The packing element according to claim 1, wherein a size of an angle A of the section of the rim-shaped body is in a range of 30° to 270°.

26. The packing element according to claim 1, wherein a size of an angle of the section of the rim-shaped body is in a range of 170° to 190°.

27. The packing element according to claim 1, wherein a radius R of the rim-shaped body is in a range of 0.5 to 4.0 times a width W of the rim-shaped body.

28. The packing element according to claim 1, wherein a radius R of the rim-shaped body is in a range of 0.75 to 4.0 times a width W of the rim-shaped body.

29. The packing element according to claim 1, wherein a width W_{f} of each rim flange portion is in a range of 0.1 to 0.4 times a width W of the rim-shaped body.

30. The packing element according to claim 1, wherein a width W_{f} of each rim flange portion is in a range of 0.15 to 0.3 times a width W of the rim-shaped body.

31. The packing element according to claim 1, wherein a differential radial length between an outer radius Rₒ and an inner radius Rᵢ of the rim-shaped body is in a range of 0.9 times Rₒ to 0.1 times a differential of the outer radius Rₒ minus the thickness T.

32. The packing element according to claim 1, wherein a differential radial length between an outer Rₒ and an inner radius Rᵢ of the rim-shaped body is in a range of 0.3 to 0.6 times Rₒ.

33. The packing element according to claim 1, including at least one through hole in the rim-shaped body.

34. The packing element according to claim 33, wherein the at least one through hole is centered in the rim-shaped body.

35. The packing element according to claim 33, wherein the at least one through hole is off center in the rim-shaped body.

36. The packing element according to claim 33, wherein the at least one through hole is at least partially located on at least one of the rim flange portions.

37. A fluid treatment process comprising of:
reducing nesting between packing elements in a fluid column by configuring the packing element to reduce or eliminate nesting between adjacent packing elements packed in a fluid column.

38. The process according to claim 37, wherein the packing elements are configured to minimize or eliminate one packing element entering into an interior space of an adjacent packing element in a fluid column.

39. The process according to claim 37, wherein the packing elements are provided with one or more lateral flange rim portions to preventingress.

40. The process according to claim 39, wherein the packing elements are provided with one or more outwardly extending flange portions.

41. The process according to claim 39, wherein the packing elements are provided with one or more inwardly extending flange portions.

42. The process according to claim 39, wherein the packing elements are provided with one or more outwardly extending protrusions and one or more inwardly extending flange portions.

43. A method of making a packed bed for a process vessel comprising packing a plurality of packing elements according to claim 1 in the process vessel.

44. The method according to claim 43, wherein the packing elements are randomly packed in the process vessel.
